(19) United States
(12) Patent Application Publication
(10) Pub. No.: US 2025/0231073 A1
(43) Pub. Date: Jul. 17, 2025

(54) LOAD SENSING ATTACHMENTS FOR MACHINE TOOL ASSEMBLIES AND MACHINE TOOL ASSEMBLIES AND METHODS FOR PERFORMING OPERATIONS ON WORKPIECES

(71) Applicant: The Boeing Company, Arlington, VA (US)

(72) Inventors: David G. Ellsworth, Kent, WA (US); John D. Sailing, SR., Covington, WA (US)

(73) Assignee: The Boeing Company, Arlington, VA (US)

(21) Appl. No.: 18/412,682

(22) Filed: Jan. 15, 2024

(51) Int. Cl. G01L 5/00; B23Q 17/09

(52) U.S. Cl. CPC G01L 5/0061; B23Q 17/0952

(57) ABSTRACT

A load sensing attachment for a machine tool assembly includes a machine tool interface, a load sensing device and a bit clamp interface. The machine tool interface couples the load sensing attachment to a drive train for a machine tool of the machine tool assembly. The load sensing device detects an axial load exerted on a housing of the machine tool when the load sensing attachment is coupled to the machine tool. The bit clamp interface couples the load sensing attachment to a bit clamp that selectively receives and secures a working bit. The bit clamp interface is coupled to the machine tool interface. A machine tool assembly for performing an operation on a workpiece includes the machine tool, the bit clamp and the load sensing attachment. A method for performing an operation on a workpiece using the machine tool assembly with the load sensing attachment is also disclosed.

### FIELD

The present disclosure relates generally to load sensing attachments for machine tool assemblies and, particularly, to sensing an axial load exerted on a housing for a machine tool of the machine tool assembly while the machine tool assembly is used to perform an operation on a workpiece. Various types of machine tool assemblies and machine tools are contemplated. The operations contemplated include drilling, countersinking, counterboring, tapping, routing, sanding, polishing, installing a fastener and removing a fastener. Use of machine tool assemblies as end effectors of articulated robots, including collaborative robots, is also contemplated. The various examples also contemplate the use of handheld machine tool assemblies.

### BACKGROUND

It is difficult to obtain a total load applied to a hand tool during various processes with various hand used tools. For example, an integrated glove with measurable pressure points and other products of this nature only provide discrete sensor inputs and do not provide the sum of the force a human is applying to the handheld tool's business end. Similar problems exist for a manipulative robot in measuring the force applies by an end effector to a machine tool assembly attached to the end effector.

Accordingly, those skilled in the art continue with research and development efforts to improve devices and techniques for measuring axial loads applied when using machine tool assemblies to work surfaces of workpieces while performing operations on the workpieces.

### SUMMARY

Disclosed are examples of load sensing attachments for machine tool assemblies, machine tool assemblies for performing operations on workpieces and methods for performing operations on workpieces. The following is a non-exhaustive list of examples, which may or may not be claimed, of the subject matter according to the present disclosure.

In an example, the disclosed load sensing attachment for a machine tool assembly includes a machine tool interface, a load sensing device and a bit clamp interface. The machine tool interface couples the load sensing attachment to a drive train for a machine tool of the machine tool assembly. The load sensing device detects an axial load exerted on a housing of the machine tool when the load sensing attachment is coupled to the machine tool. The bit clamp interface couples the load sensing attachment to a bit clamp that selectively receives and secures a working bit. The bit clamp interface is coupled to the machine tool interface.

In an example, the disclosed machine tool assembly for performing an operation on a workpiece includes a machine tool, a bit clamp and a load sensing attachment. The machine tool includes a housing, a rotational drive and a drive train. The housing defines a proximal housing portion and a distal housing portion. The rotational drive is disposed within the housing that selectively provides a rotational force. The drive train is coupled to the rotational drive and selectively rotates in response to the rotational force from the rotational drive. The bit clamp selectively receives and secures a working bit. The load sensing attachment defines a proximal attachment portion and a distal attachment portion. The proximal attachment portion is adjacent to the distal housing portion of the machine tool. The load sensing attachment includes a machine tool interface, a load sensing device and a bit clamp interface. The machine tool interface couples the load sensing attachment to the drive train of the machine tool. The load sensing device detects an axial load exerted on the housing of the machine tool when the load sensing attachment is coupled to the machine tool. The bit clamp interface couples the load sensing attachment to the bit clamp such that the bit clamp rotates in response to the rotational force. The bit clamp interface is coupled to the machine tool interface.

In an example, the disclosed method for performing an operation on a workpiece includes: (1) moving a machine tool assembly to a desired location on a work surface of the workpiece, the machine tool assembly defines a proximal end and a distal end and includes a machine tool at the proximal end, a load sensing attachment adjacent to and engaged with the machine tool and a bit clamp at the distal end and engaged with the load sensing attachment, the bit clamp securing a working bit selected for the operation; (2) activating the machine tool assembly and engaging the working bit with the work surface at the desired location; (3) performing the operation on the work surface at the desired location using the machine tool assembly and the working bit to change the workpiece; (4) detecting an axial load on the working bit at a load sensing device of the load sensing attachment, the axial load based on an axial force exerted on a housing of the machine tool during the performing of the operation; and (5) determining an axial force measurement at the load sensing device based on the axial load during the performing of the operation.

Other examples of the disclosed load sensing attachments for machine tool assemblies, machine tool assemblies for performing operations on workpieces and methods for performing operations on workpieces will become apparent from the following detailed description, the accompanying drawings and the appended claims.

### BRIEF DESCRIPTION OF THE DRAWINGS

FIG. 1 is a perspective and partially exploded view of an example of a machine tool assembly for performing an operation on a workpiece that includes a machine tool, a load sensing attachment and a bit clamp;

FIG. 2 is a perspective view of another example of a machine tool assembly with the machine tool and a partially exploded view of the load sensing attachment, a bit clamp and a working bit;

FIG. 3 is a cross-sectional view of an example of a load sensing attachment installed on a machine tool;

FIG. 4 is a perspective view of an example of an articulated robot with the machine tool assembly of FIG. 1 on an end effector attached to a robotic arm;

FIG. 5 is a functional block diagram of an example of the machine tool assembly of FIG. 2 shown facing a workpiece;

FIG. 6 is a flow diagram of an example of a method for performing an operation on a workpiece;

FIG. 7, in combination with FIG. 6, is a flow diagram of another example of a method for performing an operation on a workpiece;

FIG. 8, in combination with FIG. 6, is a flow diagram of yet another example of a method for performing an operation on a workpiece;

FIG. 9 is a flow diagram showing examples of the moving of the machine tool assembly, the activating of the machine tool assembly and the performing of the operation in the method of FIG. 6;

FIG. 10 is a block diagram of aircraft production and service methodology that implements one or more of the examples of methods for performing an operation on a workpiece disclosed herein to produce or maintain components of the aircraft; and

FIG. 11 is a schematic illustration of an aircraft that incorporates one or more examples of components produced or maintained using machine tool assemblies with load sensing attachments disclosed herein.

### DETAILED DESCRIPTION

The various examples of load sensing attachments, machine tool assemblies with load sensing attachments and methods for performing operations on workpieces using the machine tool assemblies disclosed herein provide axial load measurements during such operations. The load sensing attachment includes a load sensing device, such as a strain gage, a piezo or a load cell, to measure a reactance force applied to the machine tool assembly. The load sensing means can be placed in a location associated with the machine tool assembly that carries the full load path being applied to the machine tool assembly through the load sensor. The machine tool assembly with the load sensing attachment allows ergonomic groups to evaluate human posture and processes used on an assembly line. These evaluations can be considered with ergonomic evaluations to ensure best practices and tools are used to minimize human impact and maximize safety.

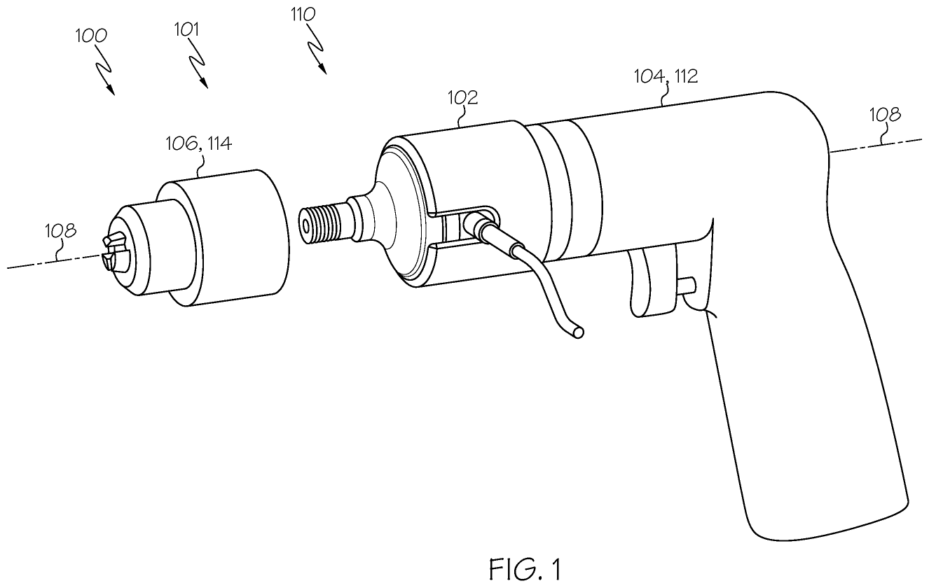

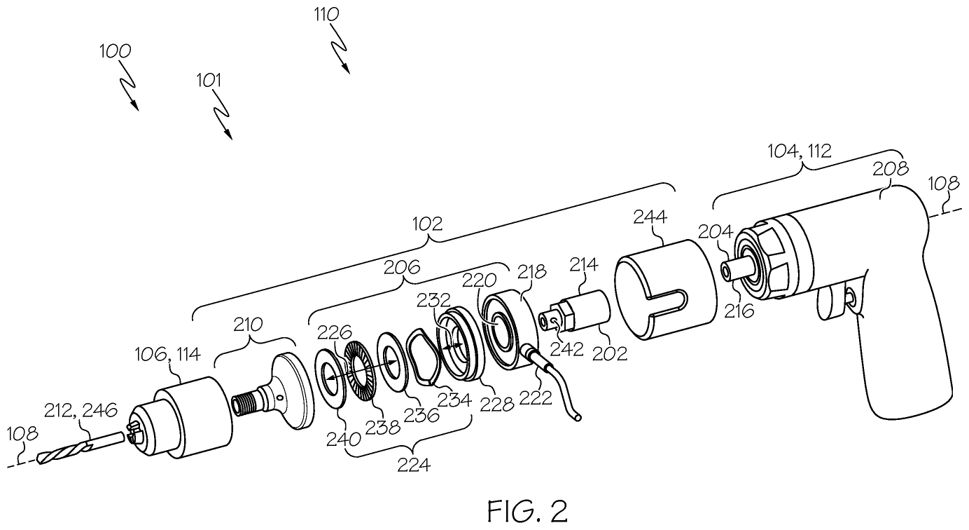

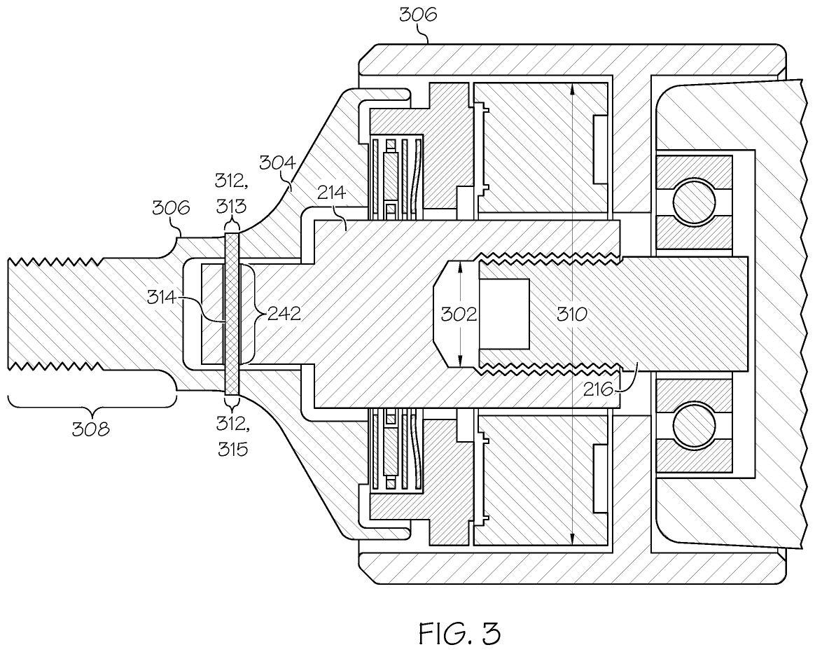

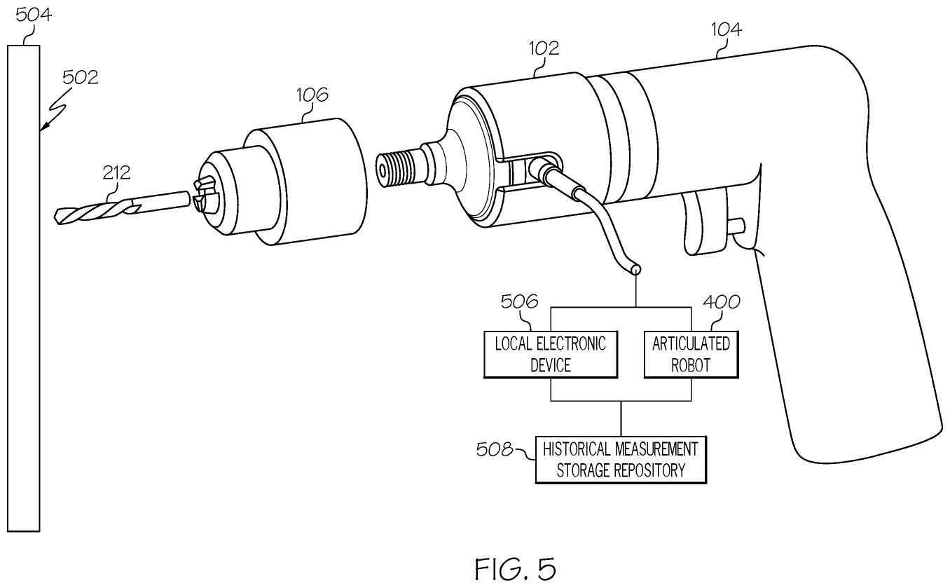

Referring generally to FIGS. 1-3 and 5, by way of examples, the present disclosure is directed to a load sensing attachment 102 for a machine tool assembly 100. FIG. 1 discloses examples of the load sensing attachment 102 and the machine tool assembly 100. FIG. 2 shows a partially exploded view of the load sensing attachment 102 of the machine tool assembly 100 along with a machine tool 104, a bit clamp 106 and a working bit 212. FIG. 3 shows a cross-sectional view of an example of the load sensing attachment 102 installed on the machine tool 104. FIG. 5 shows a functional block diagram of an example of the machine tool assembly 100 of FIG. 2 shown facing a workpiece 504.

With reference again to FIGS. 1-3 and 5, in one or more examples, a load sensing attachment 102 for a machine tool assembly 100 includes a machine tool interface 202, a load sensing device 206 and a bit clamp interface 210. The machine tool interface 202 couples the load sensing attachment 102 to a drive train 204 for a machine tool 104 of the machine tool assembly 100. The load sensing device 206 detects an axial load exerted on a housing 208 of the machine tool 104 when the load sensing attachment 102 is coupled to the machine tool 104. The bit clamp interface 210 couples the load sensing attachment 102 to a bit clamp 106 that selectively receives and secures a working bit 212. The bit clamp interface 210 coupled to the machine tool interface 202.

In another example of the load sensing attachment 102, the machine tool assembly 100 includes a power drill assembly 110, a power tap assembly, a power driver assembly, an adjustable angle power drill assembly, an adjustable angle power tap assembly, an adjustable angle power driver assembly, a 90-degree power drill assembly, a 90-degree power tap assembly, a 90-degree power driver assembly or any other suitable machine tool assembly.

In yet another example of the load sensing attachment 102, the machine tool 104 includes a power drill 112, a power tap, a power driver, an adjustable angle power drill, an adjustable angle power tap, an adjustable angle power driver, a 90-degree power drill, a 90-degree power tap, a 90-degree power driver or any other suitable machine tool.

In still another example of the load sensing attachment 102, the bit clamp 106 includes a chuck, a keyed chuck 114, a keyless chuck, a collet or any other suitable bit clamp in any suitable combination. In still yet another example of the load sensing attachment 102, the working bit 212 includes a drill bit 246, a countersink bit, a counterbore bit, a tap bit, a routing bit, a sanding bit, a polishing bit, a driver bit or any other suitable working bit.

In another example of the load sensing attachment 102, the drive train 204 translates a rotational force produced by a rotational drive in the machine tool 104 to the load sensing attachment 102 during operation of the machine tool assembly 100. In this example, the load sensing attachment 102 translates the rotational force to the bit clamp 106 and the working bit 212 during operation of the machine tool assembly 100.

In yet another example of the load sensing attachment 102, the axial load is along a longitudinal axis 108 extending from the housing 208 of the machine tool 104 through the load sensing attachment 102. In this example, the bit clamp 106 and the working bit 212 extend the longitudinal axis 108 from the load sensing attachment 102 to a work surface 502 of a workpiece 504 during operation of the machine tool assembly 100. In a further example, the work surface 502 of the workpiece 504 includes a curved portion, a double curved portion, a contoured portion, a geometrically-shaped portion, a rising ramp portion, a falling ramp portion, a two-dimensional portion or any other suitable shaped portion in any suitable combination. In another further example, the workpiece 504 includes a metal material. In an even further example, the metal material includes a titanium material, a titanium alloy material, a 6L4V titanium alloy material, a Ti-6Al-4V alloy material, an aluminum material, a nickel-chromium superalloy material, a nickel-copper alloy material, a nickel-iron alloy material, a 4340 steel alloy material or any other suitable metal material in any suitable combination.

In still another example of the load sensing attachment 102, the load sensing attachment 102 extends the drive train 204 of the machine tool 104 to the bit clamp 106. In still yet another example of the load sensing attachment 102, the machine tool interface includes a drive extension 214 to couple the load sensing attachment 102 to the drive train 204 of the machine tool 104. In a further example, the drive extension 214 of the machine tool interface 202 includes at least a partial central bore 302 with internal threads for engagement with external threads of a drive stud 216 at the drive train 204 for the machine tool 104.

In another example of the load sensing attachment 102, the load sensing device 206 includes a load cell 218, a thrust bearing assembly 224 and a reducer bushing 228. The load cell 218 disposed at a proximal portion of the load sensing device 206 to detect the axial load. The load cell 218 includes a central through hole 220 that provides a clearance fit over the machine tool interface 202 and an electrical interface 222 that provides signals indicative of axial load measurements. The thrust bearing assembly 224 disposed between the load cell 218 and the bit clamp interface 210. The thrust bearing assembly 224 includes a central aperture 226 that provides a clearance fit over the machine tool interface 202. The reducer bushing 228 disposed between the load cell 218 and the thrust bearing assembly 224. The reducer bushing 228 includes a central opening 230 that provides a clearance fit over the machine tool interface 202 and a cupped area 232 that receives and retains the thrust bearing assembly 224 between the reducer bushing 228 and the bit clamp interface 210.

In a further example, the electrical interface 222 of the load cell 218 includes an electrical connector, an external cable terminated within the load cell 218, an external interface cable connected to the electrical connector or any other suitable electrical interface in any suitable combination. In another further example, the thrust bearing assembly 224 includes a wave spring washer 234, a housing washer 236, a thrust bearing 238 and a shaft washer 240. The wave spring washer 234 adjacent to the reducer bushing 228 and disposed within the cupped area 232. The housing washer 236 is disposed within the cupped area 232 adjacent to the wave spring washer 234. The thrust bearing 238 disposed within the cupped area 232 adjacent to the housing washer 236. The shaft washer 240 disposed within the cupped area 232 adjacent to the thrust bearing 238.

In an even further example, the wave spring washer 234 biases the housing washer 236, the thrust bearing 238, the shaft washer 240 and the bit clamp interface 210 away from the reducer bushing 228 and the load cell 218. In another even further example, the wave spring washer 234 biases the housing washer 236, the thrust bearing 238, the shaft washer 240, the bit clamp interface 210, the bit clamp 106 and the working bit 212 toward a work surface 502 of a workpiece 504 during operation of the machine tool assembly 100. In yet another even further example, the thrust bearing 238 includes needle bearings mounted in slots of a cage member.

In yet another example of the load sensing attachment 102, the bit clamp interface 210 includes a body 304 and a pin 314. The body 304 includes an exterior wall 306 and an extended drive stud 308. The exterior wall 306 forming a central cavity 310 to receive a distal portion of the machine tool interface 202 and a pair of crosswise apertures 312 that align with an elongated crosswise hole 242 in the distal portion of the machine tool interface 202. The extended drive stud 308 couples the load sensing attachment 102 to the bit clamp 106. The pin 314 fits through a first aperture 313 of the pair of crosswise apertures 312, the elongated crosswise hole 242 in the distal portion of the machine tool interface 202 and a second aperture 315 of the pair of crosswise apertures 312 to secure the body 304 to the machine tool interface 202. As used in this disclosure, crosswise refers to a direction that crosses the longitudinal axis 108 without necessarily intersecting the longitudinal axis 108. The crosswise direction may be perpendicular to the longitudinal axis 108 or at any other suitable angle to the longitudinal axis 108.

In a further example, the extended drive stud 308 on the body 304 of the bit clamp interface 210 includes external threads for threaded engagement by the bit clamp 106.

In another further example, the pin 314 includes a clevis pin and a cotter pin combination, a grooved clevis pin and a retaining clip combination, a tension roll pin, a bolt and a nut combination, a bolt without the nut or any other suitable pin. In an even further example, where the pin 314 includes the bolt without the nut, at least one of the pair of crosswise apertures 312 includes internal threads for threaded engagement by the bolt.

In yet another further example, the elongated crosswise hole 242 in the distal portion of the machine tool interface 202 includes a circular hole elongated by approximately 40 thousandths of an inch, approximately 35 thousandths of an inch to approximately 45 thousandths of an inch, approximately 30 thousandths of an inch to approximately 50 thousandths of an inch, approximately 20 thousandths of an inch to approximately 60 thousandths of an inch, approximately 20 thousandths of an inch to approximately 100 thousandths of an inch or elongated by any other suitable distance.

In still yet another further example, the pin 314 of the bit clamp interface 210, a wave spring washer 234 of a thrust bearing assembly 224 in the load sensing device 206 and the elongated crosswise hole 242 in the distal portion of the machine tool interface 202 form a slip joint mechanism that permits axial movement of the bit clamp interface 210 in response to an axial force being applied to the housing 208 of the machine tool 104. In an even further example, the axial load is detected by a load cell 218 of the load sensing device 206 in relation to the axial force applied to the housing 208 of the machine tool 104 which produces a load measurement indicative of the axial load at the working bit 212 in the bit clamp 106.

In still another example, the load sensing attachment 102 also includes an enclosure 244 sized to cover the machine tool interface 202, the load sensing device 206 and at least a portion of the bit clamp interface 210. In a further example, the enclosure 244 includes a clamshell enclosure with a fastener to secure the clamshell enclosure in a closed position.

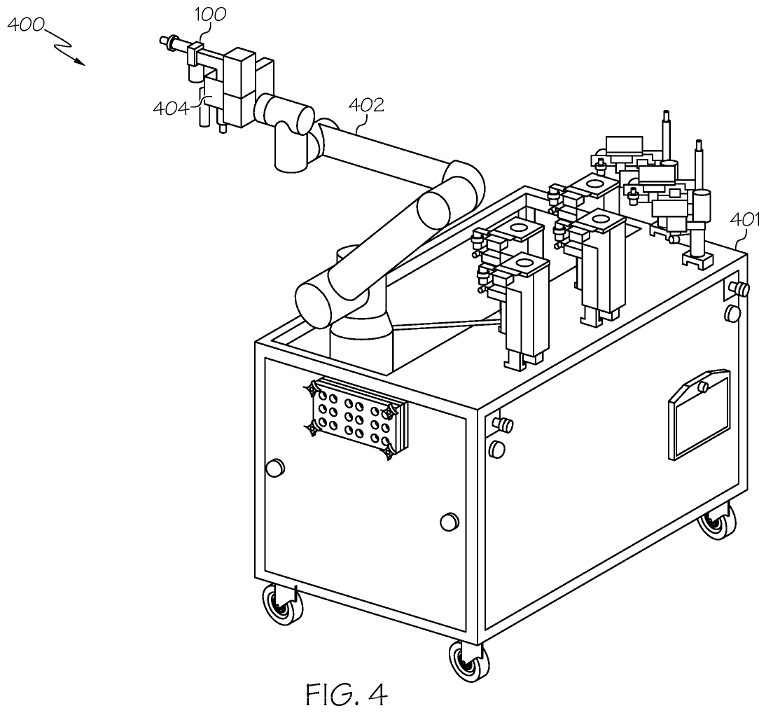

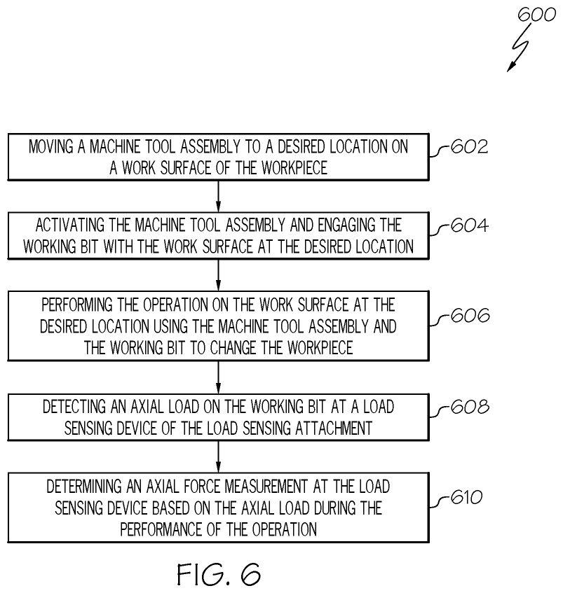

Referring generally to FIGS. 1-6, by way of examples, the present disclosure is directed to a machine tool assembly 100 for performing an operation on a workpiece 504. FIG. 1 discloses an example of the machine tool assembly 100. FIG. 2 shows a partially exploded view of a load sensing attachment 102 of the machine tool assembly 100 along with a machine tool 104, a bit clamp 106 and a working bit 212. FIG. 3 shows a cross-sectional view of an example of the load sensing attachment 102 installed on the machine tool 104. FIG. 4 discloses an example of an articulated robot 400 with the machine tool assembly 100 of FIG. 1 on an end effector 404 attached to a robotic arm 402. FIG. 5 shows a functional block diagram of an example of the machine tool assembly 100 of FIG. 2 shown facing a workpiece 504. FIG. 6 discloses an example of a method 600 for performing an operation on the workpiece 504.

Referring again to FIGS. 1-6, in one or more example, a machine tool assembly 100 for performing an operation on a workpiece 504 includes a machine tool 104, a bit clamp 106 and a load sensing attachment 102. The machine tool 104 includes a housing 208, a rotational drive and a drive train 204. The housing 208 defines a proximal housing portion and a distal housing portion. The rotational drive is disposed within the housing 208 and selectively provides a rotational force. The drive train 204 coupled to the rotational drive that selectively rotates in response to the rotational force from the rotational drive. The bit clamp 106 selectively receives and secures a working bit 212. The load sensing attachment 102 defines a proximal attachment portion and a distal attachment portion. The proximal attachment portion adjacent to the distal housing portion of the machine tool 104. The load sensing attachment 102 includes a machine tool interface 202, a load sensing device 206 and a bit clamp interface 210. The machine tool interface 202 couples the load sensing attachment 102 to the drive train 204 of the machine tool 104. The load sensing device 206 detects an axial load exerted on the housing 208 of the machine tool 104. The bit clamp interface 210 couples the load sensing attachment 102 to the bit clamp 106 such that the bit clamp 106 rotates in response to the rotational force. The bit clamp interface 210 coupled to the machine tool interface 202.

In another example, the machine tool assembly 100 includes a power drill assembly 110, a power tap assembly, a power driver assembly, an adjustable angle power drill assembly, an adjustable angle power tap assembly, an adjustable angle power driver assembly, a 90-degree power drill assembly, a 90-degree power tap assembly, a 90-degree power driver assembly or any other suitable machine tool assembly.

In yet another example of the machine tool assembly 100, the operation to be performed on the workpiece 504 includes drilling, countersinking, counterboring, tapping, routing, sanding, polishing, installing a fastener, removing a fastener or any other suitable operation.

In still another example of the machine tool assembly 100, the workpiece 504 includes a metal material. In a further example, the metal material includes a titanium material, a titanium alloy material, a 6L4V titanium alloy material, a Ti-6Al-4V alloy material, an aluminum material, a nickel-chromium superalloy material, a nickel-copper alloy material, a nickel-iron alloy material, a 4340 steel alloy material or any other suitable metal material in any suitable combination.

In still yet another example of the machine tool assembly 100, the machine tool 104 includes a power drill 112, a power tap, a power driver, an adjustable angle power drill, an adjustable angle power tap, an adjustable angle power driver, a 90-degree power drill, a 90-degree power tap, a 90-degree power driver or any other suitable machine tool.

In another example of the machine tool assembly 100, the rotational drive includes an induction motor, a universal motor, a synchronous motor, a direct current motor, a brushless motor or any other suitable rotational drive.

In yet another example of the machine tool assembly 100, the bit clamp 106 includes a chuck, a keyed chuck 114, a keyless chuck, a collet or any other suitable bit clamp in any suitable combination. In still another example of the machine tool assembly 100, the working bit 212 includes a drill bit 246, a countersink bit, a counterbore bit, a tap bit, a routing bit, a sanding bit, a polishing bit, a driver bit or any other suitable working bit.

In still yet another example of the machine tool assembly 100, the drive train 204 translates the rotational force produced by the rotational drive of the machine tool 104 to the load sensing attachment 102 during operation of the machine tool assembly 100. In this example, the load sensing attachment 102 translates the rotational force to the bit clamp 106 and the working bit 212 during operation of the machine tool assembly 100.

In another example of the machine tool assembly 100, the axial load is along a longitudinal axis 108 extending from the housing 208 of the machine tool 104 through the load sensing attachment 102. In this example, the bit clamp 106 and the working bit 212 extend the longitudinal axis 108 from the load sensing attachment 102 to a workpiece 504 during operation of the machine tool assembly 100.

In yet another example of the machine tool assembly 100, the load sensing attachment 102 extends the drive train 204 of the machine tool 104 to the bit clamp 106. In still another example of the machine tool assembly 100, the machine tool interface 202 includes a drive extension 214 to couple the load sensing attachment 102 to the drive train 204 of the machine tool 104. In a further example, the drive extension 214 of the machine tool interface 202 includes at least a partial central bore 302 with internal threads for engagement with external threads of a drive stud 216 at the drive train 204 for the machine tool 104.

In still yet another example of the machine tool assembly 100, the load sensing device 206 includes a load cell 218, a thrust bearing assembly 224 and a reducer bushing. The load cell 218 disposed at a proximal portion of the load sensing device 206 to detect the axial load. The load cell 218 includes a central through hole 220 that provides a clearance fit over the machine tool interface 202 and an electrical interface 222 that provides signals indicative of axial load measurements. The thrust bearing assembly 224 disposed between the load cell 218 and the bit clamp interface 210. The thrust bearing assembly 224 includes a central aperture 226 that provides a clearance fit over the machine tool interface 202. The reducer bushing 228 disposed between the load cell 218 and the thrust bearing assembly 224. The reducer bushing 228 includes a central opening 230 that provides a clearance fit over the machine tool interface 202 and a cupped area 232 that receives and retains the thrust bearing assembly 224 between the reducer bushing 228 and the bit clamp interface 210.

In a further example, the electrical interface 222 of the load cell 218 includes an electrical connector, an external cable terminated within the load cell 218, an external interface cable connected to the electrical connector or any other suitable electrical interface in any suitable combination.

In another further example, the load cell 218 determines an axial force measurement based on the axial load and communicates the axial force measurement to a local electronic device 506 as an electrical signal. In this example, the local electronic device 506 is configured to compare the axial force measurement to one or more predetermined thresholds. In an even further example, the local electronic device 506 is configured to trigger at least one local cue associated with the axial force measurement during the performing 606 of the operation on the workpiece 504 based at least in part on comparing the axial force measurement to the one or more predetermined thresholds. In another even further example, the local electronic device 506 is configured to store the axial force measurement in a historical measurement storage repository 508 for subsequent processing to determine improved procedures for performance of the operation and/or to confirm acceptable procedures for performance of the operation.

In yet another further example, the thrust bearing assembly 224 includes a wave spring washer 234, a housing washer 236, a thrust bearing 238 and a shaft washer 240. The wave spring washer 234 adjacent to the reducer bushing 228 and disposed within the cupped area 232. The housing washer 236 is disposed within the cupped area 232 adjacent to the wave spring washer 234. The thrust bearing 238 disposed within the cupped area 232 adjacent to the housing washer 236. The shaft washer 240 disposed within the cupped area 232 adjacent to the thrust bearing 238. In an even further example, the wave spring washer 234 biases the housing washer 236, the thrust bearing 238, the shaft washer 240 and the bit clamp interface 210 away from the reducer bushing 228 and the load cell 218. In another even further example, the wave spring washer 234 biases the housing washer 236, the thrust bearing 238 the shaft washer 240, the bit clamp interface 210, the bit clamp 106 and the working bit 212 toward a workpiece 504 during operation of the machine tool assembly 100.

In another example of the machine tool assembly 100, the bit clamp interface 210 includes a body 304 and a pin 314. The body 304 includes an exterior wall 306 and an extended drive stud 308. The exterior wall 306 forming a central cavity 310 to receive a distal portion of the machine tool interface 202 and a pair of crosswise apertures 312 that align with an elongated crosswise hole 242 in the distal portion of the machine tool interface 202. The extended drive stud 308 couples the load sensing attachment 102 to the bit clamp 106. The pin 314 fits through a first aperture 313 of the pair of crosswise apertures 312, the elongated crosswise hole 242 in the distal portion of the machine tool interface 202 and a second aperture 315 of the pair of crosswise apertures 312 to secure the body 304 to the machine tool interface 202. As used in this disclosure, crosswise refers to a direction that crosses the longitudinal axis 108 without necessarily intersecting the longitudinal axis 108. The crosswise direction may be perpendicular to the longitudinal axis 108 or at any other suitable angle to the longitudinal axis 108.

In a further example, the extended drive stud 308 on the body 304 of the bit clamp interface 210 includes external threads for threaded engagement by the bit clamp 106.

In another further example, the pin 314 includes a clevis pin and a cotter pin combination, a grooved clevis pin and a retaining clip combination, a tension roll pin, a bolt and a nut combination, a bolt without the nut or any other suitable pin. In an even further example, where the pin 314 includes the bolt without the nut, at least one of the pair of crosswise apertures 312 include internal threads for threaded engagement by the bolt.

In yet another further example, the elongated crosswise hole 242 in the distal portion of the machine tool interface 202 includes a circular hole elongated by approximately 40 thousandths of an inch, approximately 35 thousandths of an inch to approximately 45 thousandths of an inch, approximately 30 thousandths of an inch to approximately 50 thousandths of an inch, approximately 20 thousandths of an inch to approximately 60 thousandths of an inch, approximately 20 thousandths of an inch to approximately 100 thousandths of an inch or elongated by any other suitable distance.

In still another further example, the pin 314 of the bit clamp interface 210, a wave spring washer 234 of a thrust bearing assembly 224 in the load sensing device 206 and the elongated crosswise hole 242 in the distal portion of the machine tool interface 202 form a slip joint mechanism that permits axial movement of the bit clamp interface 210 in response to an axial force being applied to the housing 208 of the machine tool 104. In an even further example, the axial load is detected by a load cell 218 of the load sensing device 206 in relation to the axial force applied to the housing 208 of the machine tool 104 which produces a load measurement indicative of the axial load at the working bit 212 in the bit clamp 106.

In yet another example, the machine tool assembly 100 also includes an enclosure 244 sized to cover the machine tool interface 202, the load sensing device 206 and at least a portion of the bit clamp interface 210. In a further example, the enclosure 244 includes a clamshell enclosure with a fastener to secure the clamshell enclosure in a closed position.

In still another example, the machine tool assembly 100 is configured to be moved to a desired location on a work surface 502 of the workpiece 504 by an external control element. In a further example, the external control element includes an articulated robot 400, a collaborative robot 401, a robotic arm 402, an operator or any other suitable external control element in any suitable combination.

In another further example, the machine tool assembly 100 includes an end effector 404 attached to a robotic arm 402 of an articulated robot 400. In this example, the desired location includes a predetermined location known to the articulated robot 400. In an even further example, the articulated robot 400 includes a collaborative robot 401. In another even further example, the load sensing device 206 determines an axial force measurement based on the axial load and communicates the axial force measurement to the articulated robot 400 as an electrical signal. In this example, the articulated robot 400 is configured to compare the axial force measurement to one or more predetermined thresholds. In an even yet further example, the articulated robot 400 is configured to trigger at least one local cue associated with the axial force measurement during the performing 606 of the operation on the workpiece 504 based at least in part on comparing the axial force measurement to the one or more predetermined thresholds. In another even yet further example, the articulated robot 400 is configured to store the axial force measurement in a historical measurement storage repository 508 for subsequent processing to determine improved procedures for performance of the operation and/or to confirm acceptable procedures for performance of the operation.

In still yet another example, the machine tool assembly 100 includes a handheld machine tool assembly 101. In this example, the handheld machine tool assembly 101 is configured to be moved to a desired location on a work surface 502 of the workpiece 504 in response to an operator holding and positioning the handheld machine tool assembly 101 to the desired location. The handheld machine tool assembly 101 is activated in response to the operator turning on the handheld machine tool assembly 101 and engaging the working bit 212 of the handheld machine tool assembly 101 with the work surface 502 of the workpiece 504 at the desired location. The handheld machine tool assembly 101 performs the operation on the work surface 502 at the desired location in response to the operator using the handheld machine tool assembly 101 and the working bit 212 to change the workpiece 504.

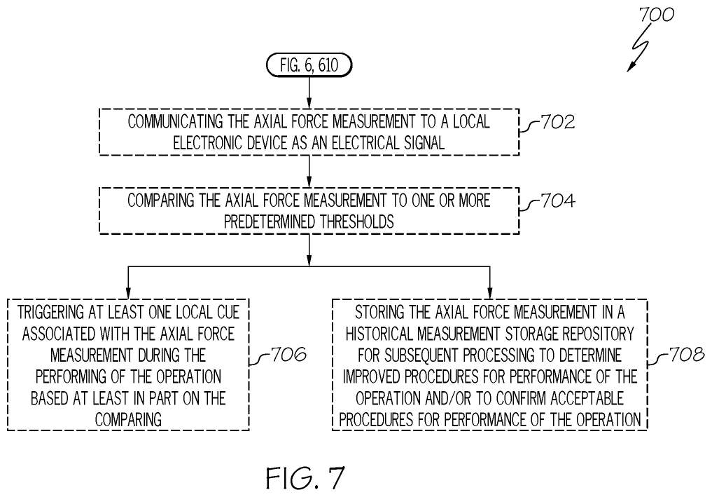

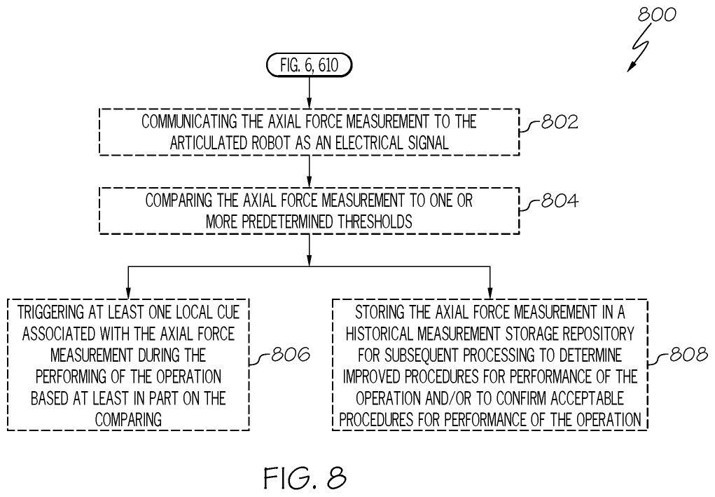

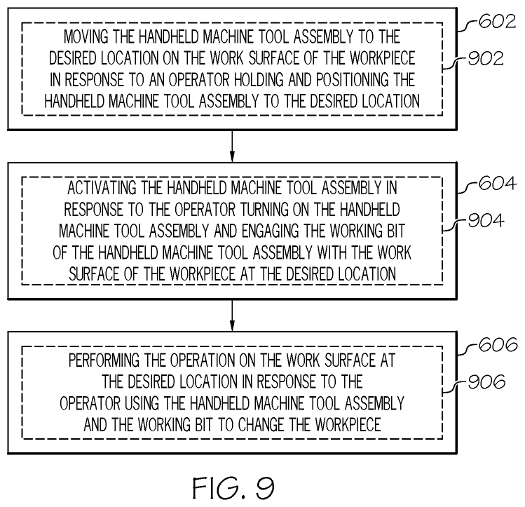

Referring generally to FIGS. 1, 2 and 4-9, by way of examples, the present disclosure is directed to a method 600, 700, 800 for performing an operation on a workpiece 504. FIG. 1 discloses examples of a machine tool assembly 100 and a load sensing attachment 102. FIG. 2 shows a partially exploded view of the load sensing attachment 102 of the machine tool assembly 100 along with a machine tool 104, a bit clamp 106 and a working bit 212. FIG. 4 discloses an example of an articulated robot 400 with the machine tool assembly 100 of FIG. 1 on an end effector 404 attached to a robotic arm 402. FIG. 5 shows a functional block diagram of an example of the machine tool assembly 100 of FIG. 2 shown facing a workpiece 504. FIG. 6 discloses an example of the method 600 for performing an operation on the workpiece 504. FIG. 7, in combination with FIG. 6, discloses an example of the method 700 for performing an operation on a workpiece. FIG. 8, in combination with FIG. 6, discloses an example of the method 800 for performing an operation on a workpiece. FIG. 9 discloses examples of the moving of the machine tool assembly, the activating of the machine tool assembly and the performing of the operation in the method of FIG. 6.

With reference again to FIGS. 1, 2, 5 and 6, in one or more examples, a method 600 (see FIG. 6) for performing an operation on a workpiece 504 includes moving 602 a machine tool assembly 100 to a desired location on a work surface 502 of the workpiece 504. The machine tool assembly 100 defines a proximal end and a distal end and includes a machine tool 104 at the proximal end, a load sensing attachment 102 adjacent to and engaged with the machine tool 104 and a bit clamp 106 at the distal end and engaged with the load sensing attachment 102. The bit clamp 106 securing a working bit 212 selected for the operation. At 604, the machine tool assembly 100 is activated and the working bit 212 is engaged with the work surface 502 at the desired location. At 606, the operation is performed on the work surface 502 at the desired location using the machine tool assembly 100 and the working bit 212 to change the workpiece 504. At 608, an axial load on the working bit 212 is detected at a load sensing device 206 of the load sensing attachment 102. The axial load based on an axial force exerted on a housing 208 of the machine tool 104 during the performing 606 of the operation. At 610, an axial force measurement is determined at the load sensing device 206 based on the axial load during the performing 606 of the operation.

In another example of the method 600, the operation to be performed on the workpiece 504 includes drilling, countersinking, counterboring, tapping, routing, sanding, polishing, installing a fastener, removing a fastener or any other suitable operation.

In yet another example of the method 600, the workpiece 504 includes a metal material. In a further example, the metal material includes a titanium material, a titanium alloy material, a 6L4V titanium alloy material, a Ti-6Al-4V alloy material, an aluminum material, a nickel-chromium superalloy material, a nickel-copper alloy material, a nickel-iron alloy material, a 4340 steel alloy material or any other suitable metal material in any suitable combination.

In still another example of the method 600, the machine tool assembly 100 includes a power drill assembly 110, a power tap assembly, a power driver assembly, an adjustable angle power drill assembly, an adjustable angle power tap assembly, an adjustable angle power driver assembly, a 90-degree power drill assembly, a 90-degree power tap assembly, a 90-degree power driver assembly or any other suitable machine tool assembly.

In still yet another example of the method 600, the work surface 502 of the workpiece 504 includes a curved portion, a double curved portion, a contoured portion, a geometrically-shaped portion, a rising ramp portion, a falling ramp portion, a two-dimensional portion or any other suitable shaped portion in any suitable combination.

In another example of the method 600, the machine tool 104 includes a power drill 112, a power tap, a power driver, an adjustable angle power drill, an adjustable angle power tap, an adjustable angle power driver, a 90-degree power drill, a 90-degree power tap, a 90-degree power driver or any other suitable machine tool.

In yet another example of the method 600, the load sensing attachment 102 includes a machine tool interface 202, the load sensing device 206 and a bit clamp interface 210. The machine tool interface 202 couples the load sensing attachment 102 to a drive train 204 for the machine tool 104 of the machine tool assembly 100. The load sensing device 206 detects the axial load exerted on the housing 208 of the machine tool 104 when the load sensing attachment 102 is coupled to the machine tool 104. The bit clamp interface 210 couples the load sensing attachment 102 to the bit clamp 106. The bit clamp interface 210 is coupled to the machine tool interface 202.

In still another example of the method 600, the bit clamp 106 includes a chuck, a keyed chuck 114, a keyless chuck, a collet or any other suitable bit clamp in any suitable combination. In still yet another example of the method 600, the working bit 212 includes a drill bit 246, a countersink bit, a counterbore bit, a tap bit, a routing bit, a sanding bit, a polishing bit, a driver bit or any other suitable working bit.

With reference again to FIGS. 1, 2 and 5-7, in one or more examples, a method 700 (see FIG. 7) for performing an operation on a workpiece 504 includes the method 600 of FIG. 6.

The method 700 continues from 610 of FIG. 6 to 702 where the axial force measurement is communicated to a local electronic device 506 as an electrical signal. At 704, the axial force measurement is compared to one or more predetermined thresholds.

In another example, the method 700 also includes triggering 706 at least one local cue associated with the axial force measurement during the performing 606 of the operation based at least in part on the comparing. In a further example, the one or more predetermined thresholds include a first threshold associated with a known degraded measurement indicating the working bit 212 is degraded and a second threshold associated with a known defective measurement indicating the working bit 212 requires replacement. In another further example, the at least one local cue includes one or more of a visual cue and an audible cue.

In yet another further example, the at least one local cue includes at least one visual cue. In this example, the at least one visual cue includes a first visual indicator reflecting the axial force measurement does not exceed the one or more predetermined thresholds and a satisfactory condition of the working bit 212, a second visual indicator reflecting the axial force measurement exceeds a first predetermined threshold and a degraded condition of the working bit 212 and a third visual indicator reflecting the axial force measurement exceeds a second predetermined threshold and replacement of the working bit 212 is needed.

In still another further example, the at least one local cue includes at least one audible cue. In this example, the at least one audible cue includes a first audible indicator reflecting the axial force measurement does not exceed the one or more predetermined thresholds and a satisfactory condition of the working bit 212, a second audible indicator reflecting the axial force measurement exceeds a first predetermined threshold and a degraded condition of the working bit 212 and a third audible indicator reflecting the axial force measurement exceeds a second predetermined threshold and replacement of the working bit 212 is needed.

In yet another example, the method 700 also includes storing 708 the axial force measurement in a historical measurement storage repository 508 for subsequent processing to determine improved procedures for performance of the operation and/or to confirm acceptable procedures for performance of the operation.

With reference again to FIGS. 4-6 and 8, in one or more examples, a method 800 (see FIG. 8) for performing an operation on a workpiece 504 includes the method 600 of FIG. 6. In the one or more examples of the method 800, the machine tool assembly 100 includes an end effector 404 attached to a robotic arm 402 of an articulated robot 400. In these examples, the desired location includes a predetermined location known to the articulated robot 400. In another example of the method 800, the articulated robot 400 includes a collaborative robot 401.

In yet another example, the method 800 continues from 610 of FIG. 6 to 802 where the axial force measurement is communicated to the articulated robot (400) as an electrical signal. At 804, the axial force measurement is compared to one or more predetermined thresholds. In a further example, the method 800 also includes triggering 806 at least one local cue associated with the axial force measurement during the performing 606 of the operation based at least in part on the comparing. In another further example, the method 800 also includes storing 808 the axial force measurement in a historical measurement storage repository 508 for subsequent processing to determine improved procedures for performance of the operation and/or to confirm acceptable procedures for performance of the operation.

With reference again to FIGS. 1, 2, 5, 6 and 9, in another example of the method 600, the machine tool assembly 100 includes a handheld machine tool assembly 101. In this example, the moving 602 of the machine tool assembly 100 includes moving 902 (see FIG. 9) the handheld machine tool assembly 101 to the desired location on the work surface 502 of the workpiece 504 in response to an operator holding and positioning the handheld machine tool assembly 101 to the desired location. The activating 604 of the machine tool assembly 100 includes activating 904 the handheld machine tool assembly 101 in response to the operator turning on the handheld machine tool assembly 101 and engaging the working bit 212 of the handheld machine tool assembly 101 with the work surface 502 of the workpiece 504 at the desired location. The performing 606 of the operation includes performing 906 the operation on the work surface 502 at the desired location in response to the operator using the handheld machine tool assembly 101 and the working bit 212 to change the workpiece 504.

Examples of the load sensing attachments 102 for the machine tool assemblies 100, the machine tool assemblies 100 for performing operations on workpieces 504 and the methods 600, 700, 800 for performing operations on workpieces 504 may be related to or used in the context of aircraft manufacturing. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may be implemented to produce components and other equipment in various types of vehicles and in the construction of various types of buildings.

The preceding detailed description refers to the accompanying drawings, which illustrate specific examples described by the present disclosure. Other examples having different structures and operations do not depart from the scope of the present disclosure. Like reference numerals may refer to the same feature, element or component in the different drawings. Throughout the present disclosure, any one of a plurality of items may be referred to individually as the item and a plurality of items may be referred to collectively as the items and may be referred to with like reference numerals. Moreover, as used herein, a feature, element, component or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic and/or operational step described in connection with the example is included in at least one aspect, embodiment and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component or hardware “configured to” perform a specified function is indeed capable of performing the specified function without any alteration, rather than merely having potential to perform the specified function after further modification. In other words, the system, apparatus, device, structure, article, element, component or hardware “configured to” perform a specified function is specifically selected, created, implemented, utilized, programmed and/or designed for the purpose of performing the specified function. As used herein, “configured to” denotes existing characteristics of a system, apparatus, structure, article, element, component or hardware that enable the system, apparatus, structure, article, element, component or hardware to perform the specified function without further modification. For purposes of this disclosure, a system, apparatus, device, structure, article, element, component or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels and are not intended to impose ordinal, positional or hierarchical requirements on the items to which these terms refer. Moreover, reference to, e.g., a “second” item does not require or preclude the existence of, e.g., a “first” or lower-numbered item and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B and item C” may include, without limitation, item A or item A and item B. This example also may include item A, item B and item C or item B and item C. In other examples, “at least one of” may be, for example, without limitation, two of item A, one of item B and ten of item C; four of item B and seven of item C; and other suitable combinations. As used herein, the term “and/or” and the “/” symbol includes any and all combinations of one or more of the associated listed items.

As used herein, the terms “coupled,” “coupling,” and similar terms refer to two or more elements that are joined, linked, fastened, attached, connected, put in communication or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

In FIGS. 1-5, referred to above, may represent functional elements, features or components thereof and do not necessarily imply any particular structure. Accordingly, modifications, additions and/or omissions may be made to the illustrated structure. Additionally, those skilled in the art will appreciate that not all elements, features and/or components described and illustrated in FIGS. 1-5, referred to above, need be included in every example and not all elements, features and/or components described herein are necessarily depicted in each illustrative example. Accordingly, some of the elements, features and/or components described and illustrated in FIGS. 1-5 may be combined in various ways without the need to include other features described and illustrated in FIGS. 1-5, other drawing figures and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 1-5, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features and/or components that serve a similar, or at least substantially similar, purpose are labeled with like numbers in each of FIGS. 1-5 and such elements, features and/or components may not be discussed in detail herein with reference to each of FIGS. 1-5. Similarly, all elements, features and/or components may not be labeled in each of FIGS. 1-5, but reference numerals associated therewith may be utilized herein for consistency.

In FIGS. 6-9, referred to above, the blocks may represent operations, steps and/or portions thereof and lines connecting the various blocks do not imply any particular order or dependency of the operations or portions thereof. It will be understood that not all dependencies among the various disclosed operations are necessarily represented. FIGS. 6-9 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage or characteristic described in connection with an example is included in at least one example. Thus, discussion of features, advantages and similar language used throughout the present disclosure may, but does not necessarily, refer to the same example.

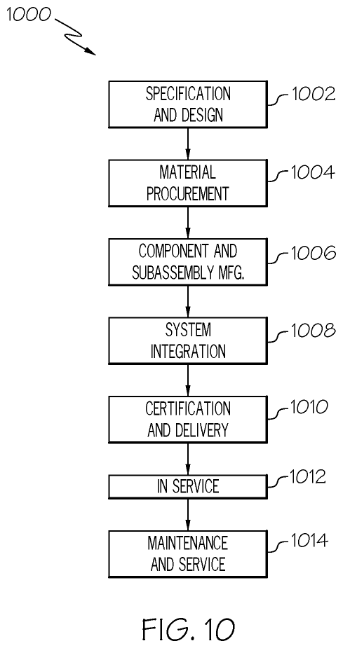

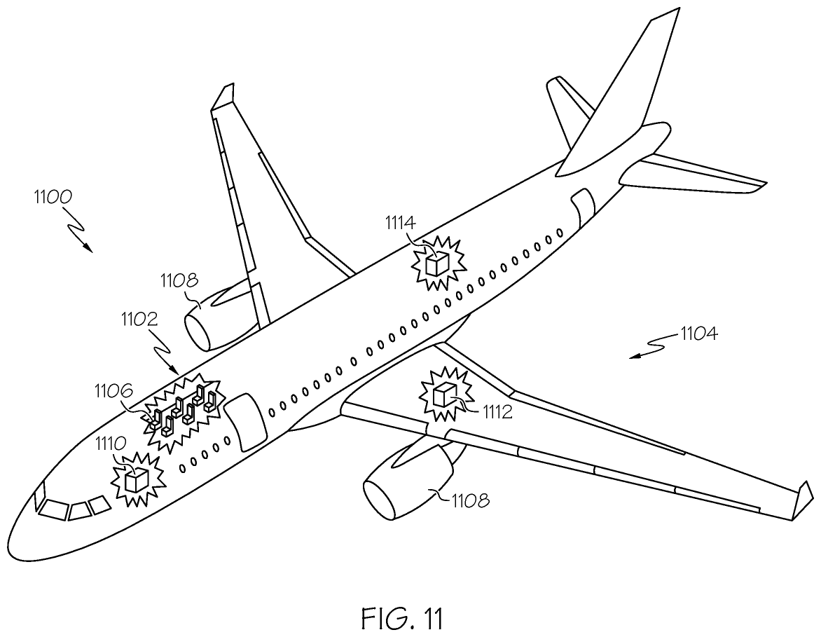

Examples of the subject matter disclosed herein may be described in the context of aircraft manufacturing and service method 1000 as shown in FIG. 10 and aircraft 1100 as shown in FIG. 11. In one or more examples, the disclosed methods and systems for associating test data for a part under test with an end item coordinate system may be used in aircraft manufacturing. During pre-production, the service method 1000 may include specification and design (block 1002) of aircraft 1100 and material procurement (block 1004). During production, component and subassembly manufacturing (block 1006) and system integration (block 1008) of aircraft 1100 may take place. Thereafter, aircraft 1100 may go through certification and delivery (block 1010) to be placed in service (block 1012). While in service, aircraft 1100 may be scheduled for routine maintenance and service (block 1014). Routine maintenance and service may include modification, reconfiguration, refurbishment, etc. of one or more systems of aircraft 1100.

Each of the processes of the service method 1000 may be performed or carried out by a system integrator, a third party and/or an operator (e.g., a customer). For the purposes of this description, a system integrator may include, without limitation, any number of aircraft manufacturers and major-system subcontractors; a third party may include, without limitation, any number of vendors, subcontractors and suppliers; and an operator may be an airline, leasing company, military entity, service organization and so on.

As shown in FIG. 11, aircraft 1100 produced by the service method 1000 may include airframe 1102 with a plurality of high-level systems 1104 and interior 1106. Examples of high-level systems 1104 include one or more of propulsion system 1108, electrical system 1110, hydraulic system 1112 and environmental system 1114. Any number of other systems may be included. Although an aerospace example is shown, the principles disclosed herein may be applied to other industries, such as the automotive industry. Accordingly, in addition to aircraft 1100, the principles disclosed herein may apply to other vehicles, e.g., land vehicles, marine vehicles, space vehicles, etc.

The disclosed systems and methods for associating test data for a part under test with an end item coordinate system may be employed during any one or more of the stages of the manufacturing and service method 1000. For example, components or subassemblies corresponding to component and subassembly manufacturing (block 1006) may be fabricated or manufactured in a manner similar to components or subassemblies produced while aircraft 1100 is in service (block 1012). Also, one or more examples of the system(s), method(s) or combination thereof may be utilized during production stages (block 1006 and block 1008), for example, by substantially expediting assembly of or reducing the cost of aircraft 1100. Similarly, one or more examples of the system or method realizations or a combination thereof, may be utilized, for example and without limitation, while aircraft 1100 is in service (block 1012) and/or during maintenance and service (block 1014).

The described features, advantages and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the load sensing attachments 102 for the machine tool assemblies 100, the machine tool assemblies 100 for performing operations on workpieces 1202 and the methods 600, 700, 800 for performing operations on workpieces 504 have been shown and described, modifications may occur to those skilled in the art upon reading the specification. The present application includes such modifications and is limited only by the scope of the claims.

1. A load sensing attachment for a machine tool assembly, comprising:
a machine tool interface to couple the load sensing attachment to a drive train for a machine tool of the machine tool assembly;
a load sensing device to detect an axial load exerted on a housing of the machine tool when the load sensing attachment is coupled to the machine tool; and
a bit clamp interface to couple the load sensing attachment to a bit clamp that selectively receives and secures a working bit, the bit clamp interface coupled to the machine tool interface.

2. The load sensing attachment of claim 1 wherein the machine tool assembly comprises at least one of a power drill assembly, a power tap assembly, a power driver assembly, an adjustable angle power drill assembly, an adjustable angle power tap assembly, an adjustable angle power driver assembly, a 90-degree power drill assembly, a 90-degree power tap assembly and a 90-degree power driver assembly.

3. The load sensing attachment of claim 1 wherein the machine tool comprises at least one of a power drill, a power tap, a power driver, an adjustable angle power drill, an adjustable angle power tap, an adjustable angle power driver, a 90-degree power drill, a 90-degree power tap and a 90-degree power driver.

4. The load sensing attachment of claim 1 wherein the bit clamp comprises at least one of a chuck, a keyed chuck, a keyless chuck, and a collet.

5. The load sensing attachment of claim 1 wherein the working bit comprises at least one of a drill bit, a countersink bit, a counterbore bit, a tap bit, a routing bit, a sanding bit, a polishing bit and a driver bit.

6. The load sensing attachment of claim 1 wherein the drive train translates a rotational force produced by a rotational drive in the machine tool to the load sensing attachment during operation of the machine tool assembly, and
wherein the load sensing attachment translates the rotational force to the bit clamp and the working bit during operation of the machine tool assembly.

7. The load sensing attachment of claim 1 wherein the axial load is along a longitudinal axis extending from the housing of the machine tool through the load sensing attachment, and
wherein the bit clamp and the working bit extend the longitudinal axis from the load sensing attachment to a work surface of a workpiece during operation of the machine tool assembly.

8. The load sensing attachment of claim 7 wherein the work surface of the workpiece comprises at least one of a curved portion, a double curved portion, a contoured portion, a geometrically-shaped portion, a rising ramp portion, a falling ramp portion and a two-dimensional portion.

9-10. (canceled)

11. The load sensing attachment of claim 1 wherein the load sensing attachment extends the drive train of the machine tool to the bit clamp.

12. The load sensing attachment of claim 1, the machine tool interface comprising:
a drive extension to couple the load sensing attachment to the drive train of the machine tool.

13. (canceled)

14. The load sensing attachment of claim 1, the load sensing device comprising:
a load cell disposed at a proximal portion of the load sensing device to detect the axial load, the load cell comprising a central through hole that provides a clearance fit over the machine tool interface and an electrical interface that provides signals indicative of axial load measurements;
a thrust bearing assembly disposed between the load cell and the bit clamp interface, the thrust bearing assembly comprising a central aperture that provides a clearance fit over the machine tool interface; and
a reducer bushing disposed between the load cell and the thrust bearing assembly, the reducer bushing comprising a central opening that provides a clearance fit over the machine tool interface and a cupped area that receives and retains the thrust bearing assembly between the reducer bushing and the bit clamp interface.

15. (canceled)

16. The load sensing attachment of claim 14, the thrust bearing assembly comprising:
a wave spring washer adjacent to the reducer bushing and disposed within the cupped area;
a housing washer disposed within the cupped area adjacent to the wave spring washer;
a thrust bearing disposed within the cupped area adjacent to the housing washer; and
a shaft washer disposed within the cupped area adjacent to the thrust bearing.

17-19. (canceled)

20. The load sensing attachment of claim 1, the bit clamp interface comprising:
a body comprising an exterior wall and an extended drive stud, the exterior wall forming a central cavity to receive a distal portion of the machine tool interface and a pair of crosswise apertures that align with an elongated crosswise hole in the distal portion of the machine tool interface, the extended drive stud couples the load sensing attachment to the bit clamp; and
a pin that fits through a first aperture of the pair of crosswise apertures, the elongated crosswise hole in the distal portion of the machine tool interface and a second aperture of the pair of crosswise apertures to secure the body to the machine tool interface.

21. The load sensing attachment of claim 20 wherein the extended drive stud on the body of the bit clamp interface comprises external threads for threaded engagement by the bit clamp.

22. The load sensing attachment of claim 20 wherein the pin comprises at least one of a clevis pin and a cotter pin combination, a grooved clevis pin and a retaining clip combination, a tension roll pin, a bolt and a nut combination and a bolt without the nut.

23. (canceled)

24. The load sensing attachment of claim 20 wherein the elongated crosswise hole in the distal portion of the machine tool interface comprises a circular hole elongated by at least one of approximately 40 thousandths of an inch, approximately 35 thousandths of an inch to approximately 45 thousandths of an inch, approximately 30 thousandths of an inch to approximately 50 thousandths of an inch, approximately 20 thousandths of an inch to approximately 60 thousandths of an inch and approximately 20 thousandths of an inch to approximately 100 thousandths of an inch.

25. The load sensing attachment of claim 20 wherein the pin of the bit clamp interface, a wave spring washer of a thrust bearing assembly in the load sensing device and the elongated crosswise hole in the distal portion of the machine tool interface form a slip joint mechanism that permits axial movement of the bit clamp interface in response to an axial force being applied to the housing of the machine tool.

26. (canceled)

27. The load sensing attachment of claim 1, further comprising:
an enclosure sized to cover the machine tool interface, the load sensing device and at least a portion of the bit clamp interface.

28. (canceled)

29. A machine tool assembly for performing an operation on a workpiece, comprising:
a machine tool, comprising:
a housing defining a proximal housing portion and a distal housing portion;
a rotational drive disposed within the housing that selectively provides a rotational force; and
a drive train coupled to the rotational drive that selectively rotates in response to the rotational force from the rotational drive;
a bit clamp that selectively receives and secures a working bit; and
a load sensing attachment defining a proximal attachment portion and a distal attachment portion, the proximal attachment portion adjacent to the distal housing portion of the machine tool, the load sensing attachment comprising:
a machine tool interface couples the load sensing attachment to the drive train of the machine tool;
a load sensing device detects an axial load exerted on the housing of the machine tool; and
a bit clamp interface couples the load sensing attachment to the bit clamp such that the bit clamp rotates in response to the rotational force, the bit clamp interface coupled to the machine tool interface.

30-67. (canceled)

68. A method for performing an operation on a workpiece, the method comprising:
moving a machine tool assembly to a desired location on a work surface of the workpiece, the machine tool assembly defining a proximal end and a distal end and comprising a machine tool at the proximal end, a load sensing attachment adjacent to and engaged with the machine tool and a bit clamp at the distal end and engaged with the load sensing attachment, the bit clamp securing a working bit selected for the operation;
activating the machine tool assembly and engaging the working bit with the work surface at the desired location;
performing the operation on the work surface at the desired location using the machine tool assembly and the working bit to change the workpiece;
detecting an axial load on the working bit at a load sensing device of the load sensing attachment, the axial load based on an axial force exerted on a housing of the machine tool during the performing of the operation; and
determining an axial force measurement at the load sensing device based on the axial load during the performing of the operation.

69-90. (canceled)
